(19) United States
(12) Patent Application Publication
(10) Pub. No.: US 2014/0136164 A1
(43) Pub. Date: May 15, 2014

(54) ANALYTIC CONTINUATIONS TO THE CONTINUUM LIMIT IN NUMERICAL SIMULATIONS OF WAFER RESPONSE

(71) Applicant: Barak Bringoltz, Rishon Le Tzion (IL)

(72) Inventor: Barak Bringoltz, Rishon Le Tzion (IL)

(73) Assignee: KLA -Tencor Corporation, Milpitas, CA (US)

(21) Appl. No.: 13/834,753

(22) Filed: Mar. 15, 2013

Related U.S. Application Data
(60) Provisional application No. 61/724,661, filed on Nov. 9, 2012.

(51) Int. Cl. G06F 17/50

(52) U.S. Cl. CPC G06F 17/5018
USPC 703/2

(57) ABSTRACT

Simulations of metrology measurements of a structure may be performed on a metrology model of the structure at two or more different truncation orders up to a maximum truncation order. The simulation results can be fitted to a function of a form that reflects the fact that a truncation order of infinity is an analytic point that admits Taylor series expansion. The function can be extrapolated to a truncation order approaching infinity limit to obtain a high fidelity result. Fitted parameters for the function can be obtained using simulation results for two or more truncation orders that are less than the maximum truncation by fitting the simulation results for the truncation orders to the function. A simulated metrology signal can be obtained by performing a simulation using an optimized truncation order that is less than the maximum truncation order, the function and the one or more fitted parameters.

### CLAIM PRIORITY

This application claims the priority benefit of commonly owned, co-pending U.S. Provisional Patent Application No. 61/724,661, to Barak Bringoltz, filed Nov. 9, 2012, and entitled “ANALYTIC CONTINUATIONS TO THE CONTIUUM LIMIT IN THE NUMERICAL SIMULATIONS OF WAFERS' ELECTROMAGNETIC RESPONSE” the entire disclosures of which are incorporated herein by reference.

### FIELD OF THE INVENTION

Embodiments of the present invention generally relate to metrology, and more particularly, to computationally efficient optical metrology.

### BACKGROUND OF THE INVENTION

Semiconductor fabrication processes are among the most sophisticated and complex processes in manufacturing. Monitoring and evaluation of semiconductor fabrication processes on the circuit structures and other types of structures, (e.g., resist structures), is necessary to ensure the manufacturing accuracy and to ultimately achieve the desired performance of the finished device. With the development trend in miniature electronic devices, the ability to examine microscopic structures and to detect microscopic defects becomes crucial to the fabrication processes. Optical metrology tools are particularly well suited for measuring microelectronic structures. Optical metrology usually involves directing an incident beam of radiation or particles at a structure, measuring the resulting scattered beam, and analyzing the scattered beam to determine various characteristics, such as the profile of the structure.

Scatterometry is one type of optical metrology technologies that may be used for the measurement of diffracting structures. Most scatterometry systems use a modeling approach in which a theoretical model is defined for each physical structure that will be analyzed and the resulting scatter signature (e.g., scatterometry signals) is mathematically calculated. The results of the calculation are compared to the measured data of a target structure. When the correspondence between the calculated data and the measurements are within an acceptable level of fitness, the theoretical model is considered to be an accurate description of the target structure. Thus, the characteristics of the theoretical model and the physical structure of the target should be very similar. If the calculated data does not fit well with the measurements from the sample, one or more variable parameters in the theoretical model may be adjusted. The calculation of the resulting scatter signature for the adjusted model is performed once again. The process of parameter modification and data calculation is repeated until the fit between the calculated data and the measured scatter signature is within tolerance. As target structures become more complex, the calculations become more complex and time consuming.

In order to overcome the calculation complexity, some systems have pre-generated libraries of predicted measurements that can be compared with the measurements of a target structure. In particular, multiple theoretical models with varying parameters are used and the resulting scatter signature for each variation is calculated and stored in a library. When the measurements of a target are obtained, the libraries are searched to find the best fit. The use of libraries speeds the analysis process by allowing theoretical results to be computed once and reused many times. However, construction of the libraries is still time consuming. Especially when the target structure is complicated, modeling the target can be difficult, time consuming and require a large amount of memory.

One of the common techniques for calculating optical diffraction for scatterometry models is known as rigorous coupled wave analysis (RCWA). In RCWA, the profiles of periodic structures are approximated by a number of sufficiently thin planar grating slabs. RCWA involves three main operations: (1) Fourier expansion of the field inside the grating; (2) calculation of the eigenvalues and eigenvectors of a constant coefficient matrix that characterizes the diffracted signal; and (3) solution of a linear system deduced from the boundary matching conditions.

The accuracy of the RCWA solution depends, in part, on the number of terms retained in the space-harmonic expansion of the wave fields, with conservation of energy being satisfied in general. The number of terms retained is often referred to as the truncation order, which herein we denote by T. The Fourier expansion of the simulated structure is done in each of the directions the structure varies and so one has a truncation order for each of these directions. For example, a one-dimensional structure (e.g. a one-dimensional grating) that varies along the x-direction and remains unchanged along the y-direction has a single truncation order we denote by T. In contrast a two-dimensional structure (e.g. a two-dimensional grating) is Fourier decomposed in two dimensions and so has two truncation orders we denote by Tₓ and T_{y}. The RCWA requires the calculation and manipulation of square matrices whose dimension is equal to the total number of Fourier components N. In the one-dimensional case N=Tₓ and in the two-dimensional case N=TₓT_{y}. The time required to perform the full RCWA calculation is dominated by a single matrix eigenvalue calculation or inversion for each layer in the model of the diffracting structure at each wavelength, and numerous matrix multiplications. Mathematically, the larger N is, the more accurate the simulations are. However, the larger N is, the more computation is required for calculating the simulated diffraction signals. In fact, the computation time is a nonlinear function of N.

The length of relative time to perform the simulation for a one-dimensional structure is proportional to (N)^{q} with the power q usually ranging between 2 and 3, depending on the calculation algorithm Accordingly, it is desirable to select truncation orders simulated at each wavelength that provide sufficient scatterometry information without overly increasing the calculation steps to perform the scatterometry simulations.

Calculations of wafer response may also be accomplished by non-RCWA simulations such as, but not restricting to, Finite-difference-time-domain (FDTD) and finite elements (FE). All these simulations have a first step which is equivalent to the step itemized (1) above. Namely the expansion of the electro-magnetic fields inside the wafer by a set of functions (in the case of RCWA these functions are plane waves and the expansion is a Fourier transform). Again, similarly to the RCWA case, we denote the number of these functions used to describe the variation of the electro-magnetic waves in the x and y spatial directions by Tₓ and T_{y} and henceforth refer to them as the truncation orders in the X and Y directions. Here, again, the calculation involves the diagonalization of N-by-N matrices with N=TₓT_{y} and the calculation cost of the simulation will be a non-linear function of N, typically scaling like N^{q} with q between 2 and 3.

### SUMMARY

The present disclosure discloses embodiments of a method of generating simulated metrology data at lower computational effort. The method comprises performing simulations of metrology measurements of a structure on a metrology model of the structure at two or more different truncation orders up to a maximum truncation order; fitting simulation results to a function of a form that reflects the fact that a truncation order of infinity is an analytic point that admits a Taylor series expansion; extrapolating the function to a truncation order approaching infinity limit to obtain a high fidelity result; obtaining fitted parameters for the function using simulation results for two or more lower truncation orders that are less than the maximum truncation by fitting the simulation results for the two or more lower truncation orders to the function; and generating a simulated metrology signal by performing a simulation using an optimized truncation order that is less than the maximum truncation order, the function and the one or more fitted parameters.

According to aspects of the present disclosure, a computer-readable storage medium containing computer executable instructions for performing simulations of metrology measurements of a structure on a metrology model of the structure at two or more different truncation orders up to a maximum truncation order; fitting results of the simulations to a function of a form that reflects the fact that the truncation order of infinity is an analytic point that admits a Taylor series expansion; extrapolating the function to a truncation order approaching infinity limit to obtain a high fidelity result; obtaining fitted parameters for the function using simulation results for two or more lower truncation orders that are less than the maximum truncation by fitting the simulation results to the two or more lower truncation orders to the function; and generating a simulated metrology signal by performing a simulation using an optimized truncation order that is less than the maximum truncation order, the function and the one or more fitted parameters.

According to another aspect of the present disclosure, an optical metrology system may comprise a metrology tool and a processor coupled to the metrology tool. The processor may configured to implement a method comprising performing simulations of metrology measurements of a structure on a metrology model of the structure at two or more different truncation orders up to a maximum truncation order; to a function of a form that reflects the fact that the truncation order of infinity is an analytic point that admits a Taylor series expansion; extrapolating the function to a truncation order approaching infinity limit to obtain a high fidelity result; obtaining fitted parameters for the function using simulation results for two or more lower truncation orders that are less than the maximum truncation by fitting the simulation results to the two or more lower truncation orders to the function; and generating a simulated metrology signal by performing a simulation using an optimized truncation order that is less than the maximum truncation order, the function and the one or more fitted parameters.

Aspects of the present disclosure hold for any type of mathematical simulation, and not only RCWA, which involves the expansion of the electro-magnetic fields inside the wafer to a given predefined of N functions. By the term “truncation order” in this disclosure we refer to the total number of functions in the expansion of the variation of the electro-magnetic fields along a given spatial direction.

### BRIEF DESCRIPTION OF THE DRAWINGS

Objects and advantages of the invention will become apparent upon reading the following detailed description and upon reference to the accompanying drawings in which:

FIG. 1 is an architectural diagram illustrating an embodiment of an optical metrology system in accordance with the present disclosure.

FIG. 2 shows results from an exemplary RCWA simulation of a one-dimensional structure in according to an aspect of the present disclosure.

FIG. 3 is a first graph showing results of reflectivity versus a function of truncation order reflecting the fact that the limit of truncation order=infinity is an analytic point of the reflectivity function, thereby admitting a Taylor series expansion in its vicinity, according to an aspect of the present disclosure.

FIG. 4 is a second graph showing results of reflectivity versus a function of truncation order reflecting the fact that the limit of truncation order=infinity is an analytic point of the reflectivity function, thereby admitting a Taylor series expansion in its vicinity, according to an aspect of the present disclosure.

FIG. 5 is a graph showing computational time required by a computer CPU per eigenvalue calculation for the simulations whose results are presented in FIG. 4 versus the square of the truncation order.

FIG. 6 is a flow chart of an embodiment of a process for selecting an optimized truncation order to use in generating a simulated diffraction signal for a periodic structure according to an aspect of the present disclosure.

### DESCRIPTION OF THE SPECIFIC EMBODIMENTS

In the following Detailed Description, reference is made to the accompanying drawings, which form a part hereof, and in which is shown by way of illustration specific embodiments in which the invention may be practiced. The drawings show illustrations in accordance with examples of embodiments, which are also referred to herein as “examples”. The drawings are described in enough detail to enable those skilled in the art to practice the present subject matter. The embodiments can be combined, other embodiments can be utilized, or structural, logical, and electrical changes can be made without departing from the scope of what is claimed. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated. The following detailed description, therefore, is not to be taken in a limiting sense, and the scope of the present invention is defined by the appended claims.

The term “one-dimensional structure” is used in the present disclosure to refer to a structure having a profile that varies in one dimension. The term “two-dimensional structure” is used herein to refer to a structure having a profile that varies in two-dimensions. Note that the term “data” can refer either to standard metrology data types such as ellipsometric angles tan Ψ and Δ, or reflectance, or to the raw data from the measurement tool (e.g., CCD counts or other electrical signals).

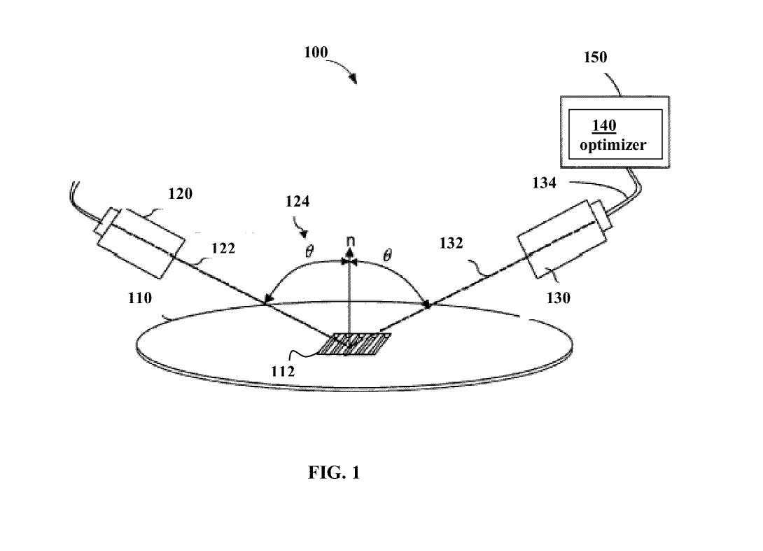

FIG. 1 is an architectural diagram illustrating an embodiment of an optical metrology system 100 that may be utilized to determine the profiles of structures on a semiconductor wafer in accordance with aspects of the present disclosure. It should be noted that the embodiments of the present disclosure apply not only to a semiconductor wafers as discussed below but also other work pieces that have periodic structures. The optical metrology system 100 may be a reflectometer, an ellipsometer, overlay tool or other optical metrology tool to measure a scattered beam or signal. The optical metrology tool typically includes a metrology beam source 120 which projects a beam 122 at the target structure 112 of a wafer 110. The metrology beam 122 is projected at an incident angle θ, or at a multitude of angles, towards the target structure 112. A metrology beam receiver 130 receives a scattered beam 132. The scattered beam 132 is measured and analyzed by the receiver 130 which outputs scattered beam data 134. The receiver may include a detector that converts optical signals to electrical signals. The detector may be configured to produce signals corresponding to different wavelength or angular components of the scattered beam 132.

By way of example, and not by way of limitation, if the metrology system 100 a reflectometer system, the scattered beam data 134 may represent a spectrum of the scattered beam 132. The spectrum may show the energy density of the scattered beam as a function of frequency or wavelength of radiation in the scattered beam 132. If the metrology system 100 is an ellipsometer system, the source 120 may include a polarizing element that can select the polarization of the metrology beam 122. The receiver 130 may also include a polarizing element that select the polarization of the scattered beam 132 that is received by the detector. In such a case, the scattered beam data 134 may include spectra as functions of wavelength and polarization.

The scattered beam data 134 is transmitted to a processor system 150 which may be part of a metrology tool or a separate standalone server connected to the tool, e.g., by a network. The processor system 150 may compare the measured diffraction beam data 134 against a library of simulated diffraction beam data representing varying combinations of critical dimensions of the target structure and resolution. The simulated diffraction data may be generated by computer simulation, e.g., RCWA. The simulated diffraction data best matching the measured diffraction beam data 134 may be determined The hypothetical profile and associated critical dimensions of the selected simulated diffraction data can be assumed to correspond to the actual cross-section profile and critical dimensions of the features of the target structure 112.

According to aspects of the present disclosure, the processor 150 may implement an optimizer 140 that is configured to determine an optimized truncation order for the simulations. The optimizer 140 may be implemented in hardware or software or some combination of hardware and software. In general, the optimizer 140 may perform simulations of metrology measurements of a structure on a metrology model of the structure at two or more different truncation orders. The simulation results may be fitted to a function of the truncation order that reflects the fact that the truncation order equal to infinity is an analytic point of the simulation results function (e.g. the reflectivity function) which admits a Taylor series expansion in its vicinity. The analytic function may then be extrapolated to truncation order approaching infinity.

In some implementations a metrology model of the structure used to perform the simulations may be optimized using the optimized truncation order for metrology measurements made at two or more different metrology configurations (e.g. wavelengths or scatterometry angles). The fitting results of the simulations as a function of truncation order may be used to determine different levels of fidelity for these different configurations. The measured data may be fitted to the simulation results in a way that weights each of the configurations (e.g. the wavelengths) while taking into account of their different fidelities.

As mentioned above, simulated diffraction data is generated for use in optical metrology. Efficient generation of a simulated diffraction signal for a given structure profile may involve selecting a value for the truncation order used in the simulation (e.g. the number of Fourier modes taking place in an RCWA calculation) which provide sufficient information without overly increasing the computational processes to perform the simulations. The present disclosure describes a method that allows performing a numerical analysis at two or three values of the truncation order and then extrapolating to the limit where the truncation order is infinite. It is less computationally intensive and may control the error margin.

In one embodiment of the present disclosure, a physical property measured in the simulation is denoted as A. A is a dimensionless number formed from the property of a target structure to be measured (e.g., the CD of a grating) and other properties with the same physical dimension (e.g., the height of a grating). The analytic function A needs to have a finite limit when the numerical parameters of the simulations approach their physical values. For example, A needs to have a finite limit when the truncation order T of RCWA of the simulations approach infinity. By way of example, A may be a Jones matrix.

If the parameters that distinguish the numerical approximation of the physical system and the real physical system are denoted by a₁, a₂, a₃, etc, whose limiting physical values are zero, then the main paradigm of the present disclosure may be as follows:

$$A ( {a}_{1 , 2 , 3 …} ) = {\prod }_{i = 1 , 2 , 3 …} {\sum }_{{n}_{i} = 1 , 2 , 3 , …} {a}_{i}^{{n}_{i}} \times {f}_{{n}_{i}} \qquad Equation ( 1 )$$

According to Equation (1), the physical limit of the numerically approximated system is an analytic point in the parameter space spanned by the variables αᵢ. As such, this point may be expanded around and expect the expansion to converge, at least asymptotically. In one example, for a two dimensional periodic structure simulated with RCWA, we have

$${a}_{i} = \frac{2 π}{{T}_{i}}$$

with i=1, 2, and Tᵢ are the truncation orders of the RCWA in the i=1,2 dimensions (x and y correspondingly). The coefficients fₙ_{ᵢ} depend on the details of the simulated stack, and reflect the sensitivity of the system to its specific RCWA numerical implementation. In the so called scaling window, the expansion in Equation (1) is well described by the leading orders, and if α_{1,2,3 . . .} are taken to be small enough, then leading (zeroth order in α_{1,2,3 . . .} ) plus first sub-leading contribution (first order in α_{1,2,3 . . .} ) to A(α_{1,2,3 . . .} ) is a good approximation for the full function. In addition, for a system having some simple symmetries, such as the symmetry to reflection, the expansion in Equation (1) will have only even powers of α_{1,2,3} and the convergence will be faster.

The embodiments of the present disclosure is first to calculate A(α_{1,2,3 . . .} ) in numerical simulations that are within the so called scaling window, which is the range of values of α_{1,2,3 . . .} where Equation (1) is a good approximation. Simulations are performed on a hypothetical model for several different values of truncation order T. In one example, where one uses RCWA, three simulations may be performed at increments of truncation order of about 10. The simulation data is then plotted versus a function of the truncation orders that goes to zero as the truncation orders goes to infinity reflecting the fact that the limit in which the truncation order approaches infinity is an analytic point which admits a Taylor series expansion for physical quantities in 1/(truncation order). Therefore any physical quantity that is calculated by the simulations may be fitted automatically using standard technique, such as a best order polynomial in an iterative fashion. By way of example, such an iterative process Could fit

$${C}_{0} + \frac{{C}_{1}}{T} ,$$

and then fit

$${C}_{0} + \frac{{C}_{1}}{T} + \frac{{C}_{2}}{{T}^{2}} ,$$

etc. It should be noted not to over-fit by performing same fitting for some subset of the data and make sure to have the same trend.

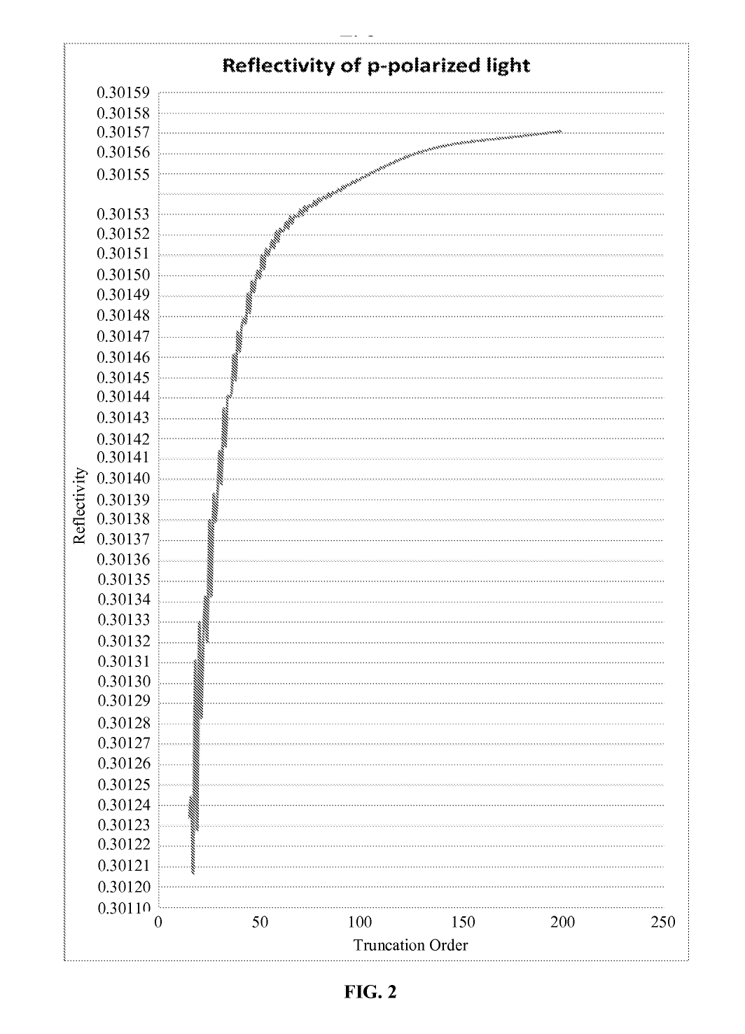

As an example, FIG. 2 shows results from a RCWA simulation of a one-dimensional structure. The grating pitch equals 240 nm, the wavelength 465 nm, the CD-100 nm. In the simulations, one of the numerical parameters that distinguish the numeric from its physical point is the truncation orders along the x-axis Tₓ. For ease of discussion, the scalar reflectivity R is plotted in the p-channel for an azimuthal angle equal to about 10 degrees and an inclination angle equal to about 15 degree, versus the truncation order Tₓ.

The next step is to extrapolate the fitted function representing A to its physical value A(α_{1,2,3 . . .} =0), i.e., when T approaches infinity or

$$\frac{1}{T}$$

approaches 0. Empirical studies show that, due to reflection symmetry, a very good fitting ansatz is a linear function in α_{1,2,3 . . .} ².

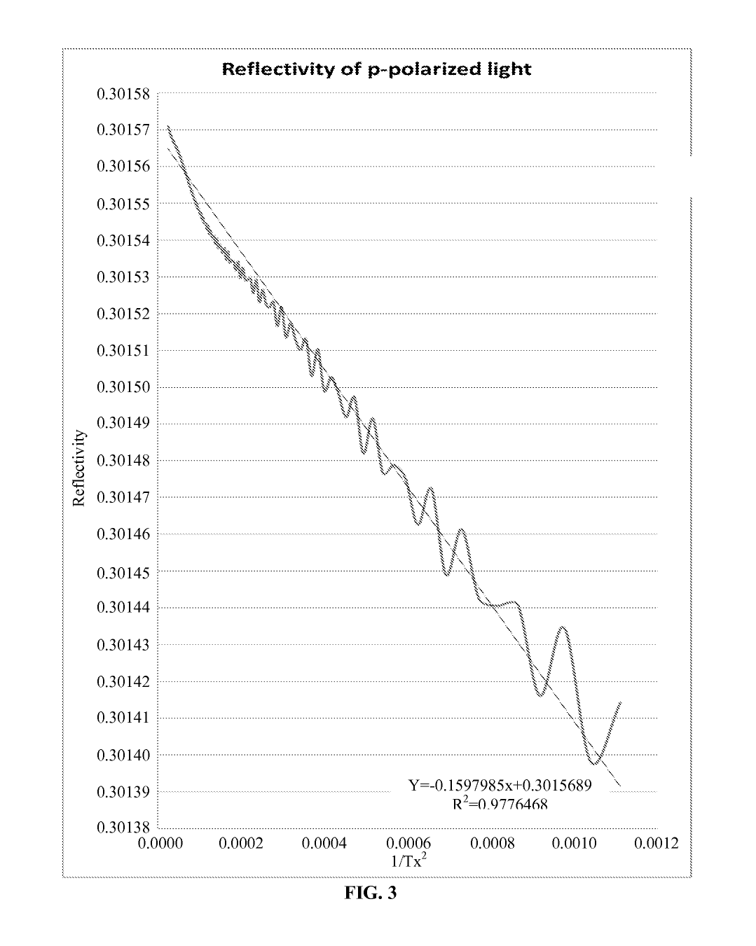

FIG. 3 shows simulated p-polarized reflectivity versus

$${a}^{2} = {( \frac{1}{{T}_{x}} )}^{2} .$$

The notation α₁, α₂, α₃, etc. is used to denote the parameters that distinguish the numerical approximation of the physical system and the real physical system. As an example in the one-dimensional case, for the required accuracy,

$$A ( \frac{1}{{T}_{x}} )$$

may be approximated by fitting a function of the following type to the simulated data:

$$A ( \frac{1}{{T}_{x}} ) = A ( 0 ) + {f}_{1} \times {( \frac{1}{{T}_{x}} )}^{2} \qquad Equation ( 2 )$$

To a large extent, the deviation from the continuum is described by Equation (2). Thus, Equation (2) can be used to compensate a significant part of the accuracy penalty involved in simulation done at a finite and fixed value of Tₓ.

As seen in Table I below, the fit can be improved by adding a

$${( \frac{1}{{T}_{x}} )}^{4}$$

term to Eq(2). In one example where the simulations were performed for three values of T, these three values may be fitted to Equation (2). The present disclosure may be used for two dimensional periodic target structures. Equation (2) would then become the following

$$A ( \frac{1}{{T}_{x}} , \frac{1}{{T}_{y}} ) = A ( 0 , 0 ) + {f}_{1} \times {( \frac{1}{{T}_{x}} )}^{2} + {f}_{2} \times {( \frac{1}{{T}_{y}} )}^{2} + negligible higher order terms \qquad Eq ( 3 )$$

Two values for Tₓ and two for T_{y} are required to fit the data to Equation (3).

Also, from FIG. 3, it is found that, to numerically calculate A with at least 0.01% accuracy, one need to simulate at Tₓ≧45. By contrast, if one linearly extrapolates to Tₓ=∞ from the values of the fitted function representing A for Tₓ=20 and Tₓ=30 with the ansatz of Equation (2), the same accuracy may be reached, but with a much smaller computational effort Since the computational effort scales as (Tₓ)^{q} with q=2-3, the boost in performance can be 1.6× or 2.7× depending on q. The results for further fits performed are listed in Table I below.

TABLE I

| Fit type/data analysis | $A ( \frac{1}{{T}_{x}} = 0 )$ | R² |
|---|---|---|
| Eq(2), 100 ≦ Tₓ ≦ 200 | 0.3015785 | 0.9955 |
| Eq(2), 50 ≦ Tₓ ≦ 200 | 0.301572 | 0.9600 |
| $Eq ( 2 ) + {( \frac{1}{{T}_{x}} )}^{4} , 50 \leq {T}_{x} \leq 200$ | 0.301577 | 0.9885 |
| Eq(2), 30 ≦ Tₓ ≦ 40 | 0.301545 | 0.8072 |
| Eq(2), 15 ≦ Tₓ ≦ 40 | 0.301484 | 0.8640 |
| Eq(2), Tₓ = 30, 40 | 0.301525 | — |
| Eq(2), Tₓ = 20, 30 | 0.301482 | — |

The foregoing process of determining the optimum truncation order may be performed in a training mode where the software that executes the above instructions could be running on the metrology tool or on a server. The training mode does not require any measurements, and thus, the training mode can be done anywhere independently of the measurement. The aim of the training mode is to find the scaling window. Specifically one would perform two or more simulations of the physical structure, calculate from these simulation results the scatterometry signal one is interested in (for example a certain element of the Jones matrix), and analyze its dependence on the truncation order in view of the required accuracy in that metrology. For example, one may consider the results in Table I as an example for a training mode whereby one concludes that the optimum truncation order will be in the range of 20-30 because in that range the reflectivity is already well approximated by a linear function of 1/(Tₓ)² thereby allowing one to extrapolate from these results to the analytic point where Tₓ is infinite.

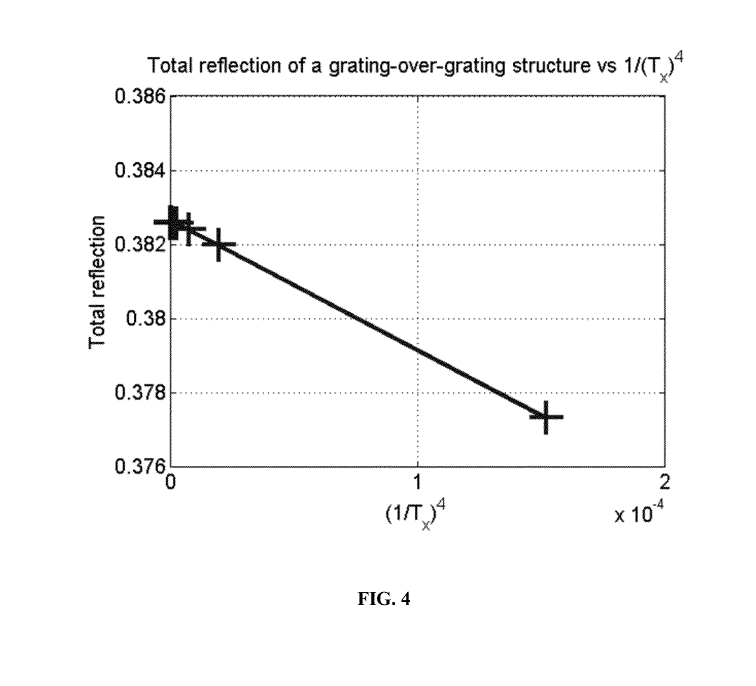

Another example is shown in FIG. 4 which shows the scalar reflectivity of a wafer containing a periodic structure with Pitch=600 nm and a wavelength of 405 nm versus (1/Tₓ)⁴. This figure shows that for this particular wafer the convergence is quartic, and most importantly, that the following equation describes the simulation results extremely well

$$A ( \frac{1}{{T}_{x}} ) = A ( 0 , 0 ) + {f}_{1} \times {( \frac{1}{{T}_{x}} )}^{4} \qquad Equation ( 4 )$$

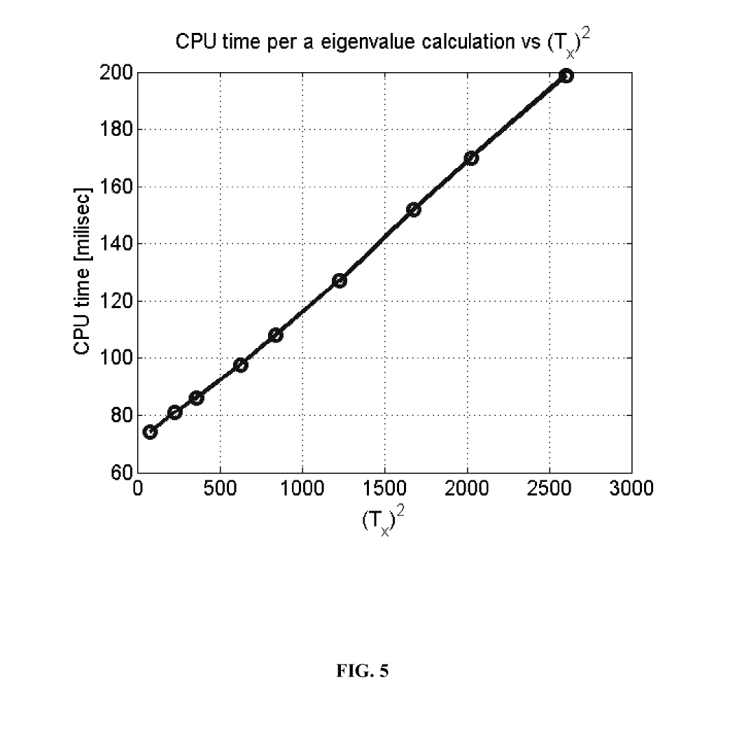

from truncation orders as low as Tₓ=9. This means one can use the invention detailed here to calculate the wafer response from a truncation order as low as 9. To estimate the boost in calculation efficiency observe FIG. 5 which shows the CPU time per eigenvalue calculation of this simulation versus (Tₓ)².

Next, a reflectance spectrum of the modeled sample may be measured. The sample may be a calibration structure having features of known dimensions. By comparing the measured spectrum to the simulation results (which are now extrapolated to the point where the truncation order is infinite) one can determine which simulation result gives a spectrum that best matches the values from the measurement. As a result, the metrology (for example the critical dimension) is obtained. In this measurement mode, fast communications between the measurement part and the simulation part are desirable. If more than two T values were used in the simulations, multiple fits may be performed. For example, if three T values were obtained, one fit may be done using the first two T values, another using the last two and a third using the first and last. An absolute value of difference between the fits may be used as an estimate for the margin of error. In one example, the fitting of the simulations data may be performed in a way that incorporates margins of error. Incorporating the margin of error gives a better result. For example, if there is wavelength for which there is a large margin of error, one could apply a lower weight to that wavelength data point in the minimization.

The optimized truncation order T may be transmitted to an optical metrology model system which may be used to model measurements made with an optical metrology system of the type shown in FIG. 1. The optical metrology model system may develop an optical metrology model of a periodic target structure using the optimized truncation order T. With the profile parameters of the optical metrology model, one or more profile parameters of the target structure may be determined based on a measured signal from the periodic target structure and a simulated signal from the optical metrology model.

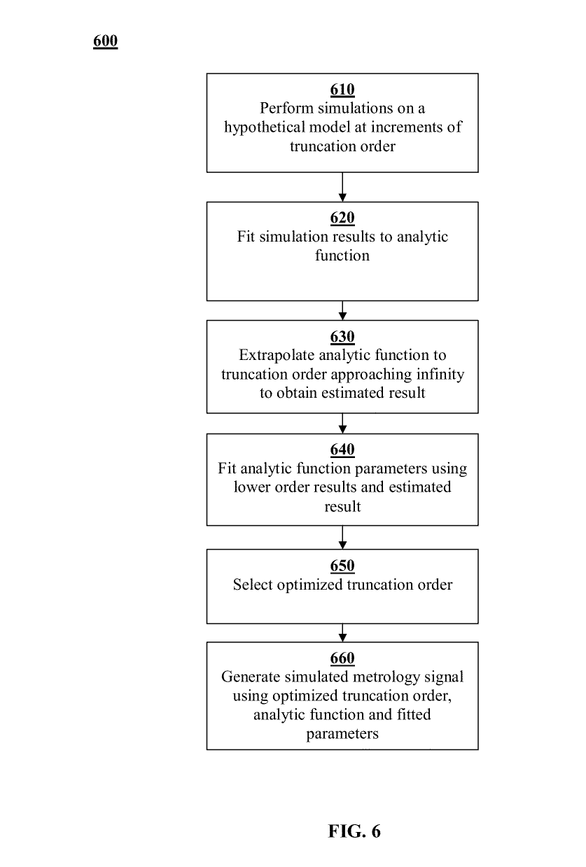

FIG. 6 is a flow chart of an embodiment of a process 600 for generating simulated metrology in accordance with aspects of the present disclosure. In step 610, simulations are performed on a hypothetical model at increments of truncation orders up to some large maximum value of truncation order. In step 620, the simulation results may be plotted versus the number of truncation orders or a function of truncation order that goes to zero as truncation order T goes to infinity, reflecting the fact that the limit where the truncation order approaches infinity is an analytic point of the simulations and admits a Taylor series expansion in its vicinity. In step 630, the analytic function may be extrapolated to T approaching infinity to obtain an approximate result. In step 640, fitted parameters may be obtained for the analytic function using simulation results for two or more lower truncation orders that are less than the maximum truncation by fitting the simulation results to the two or more lower truncation orders to the analytic function and the approximate result. By way of example, suppose the analytic function is represented by Equation (2) and applied to the case described by FIG. 2 and FIG. 3. The constant term 0.3015689 in Equation (2) is the approximate result, which represents the value of the function as truncation order T approaches infinity (or equivalently as x=(1/T) approaches zero). The term −0.1597985 multiplying (1/T)² in Equation 2 is an example of another fit parameter that can be fixed by fitting Equation (2) to the simulation data. By way of another example, the graph in FIG. 4 shows a simulation of a different wafer whose reflectivity is represented best by Equation (4). The constant term 0.3826 in Equation (4) is the approximate result, which represents the value of the function as truncation order T approaches infinity (or equivalently as x=(1/T) approaches zero). The term −34.78 multiplying (1/T)⁴ in Equation 4 is an example of another fit parameter that can be obtained by fitting Equation (4) to the simulation data. The optimized truncation orders are less than the maximum truncation order. At least one of the lower truncation orders may be less than half the maximum truncation order.

In step 650, an optimized truncation order T for metrology simulations may be selected. By way of example, and not by way of limitation the optimized truncation order may be based on comparing simulated measurement data of one or more corresponding low order simulation results to measured data. A simulated metrology signal may be generated for the periodic structure at step 660 using the optimized truncation order T, the analytic function and the fitted parameters. Specifically, by using this extra fitting term (for example f₁ in equation (2)) and the optimum truncation order one can perform the simulations at a single truncation order equal to the optimal one (which we denote by Tₒₚₜᵢₘᵤₘ), and use the result A(1/Tₒₚₜᵢₘᵤₘ) to obtain a high fidelity result for its corresponding value at the infinite limit A(0) by the following calculation which corrects the simulation result at the optimum truncation order to be as close as possible result at an infinite truncation order

$$A ( 0 ) = A ( \frac{1}{{T}_{optimum}} ) - {f}_{1} \times {( \frac{1}{{T}_{optimum}} )}^{2} \qquad Equation ( 5 )$$

Simulations done at lower values of truncation order are less computationally intensive and faster. To stress this point consider the case described in FIG. 4, FIG. 5, and Equation (4) which allows one to choose Tₒₚₜᵢₘᵤₘ=9 and then calculate the simulation result by writing

$$A ( 0 ) = A ( \frac{1}{{T}_{optimum}} ) - {f}_{1} \times {( \frac{1}{{T}_{optimum}} )}^{4} \qquad Equation ( 6 )$$

This allows one to perform the simulation at Tₒₚₜᵢₘᵤₘ=9, use Equation (6), and obtain a result which is accurate at the level of 0.01% with a calculation effort of around 74 milisecond per matrix diagonalization. To achieve the same accuracy one would need to perform the calculation at a truncation order equal to 51 would then cost around 200 milliseconds per matrix diagonalization.

Aspects of the present disclosure allow for accurate simulation of metrology measurements at lower truncation order, thereby reducing the time and processing resources required to perform the simulation.

The appended claims are not to be interpreted as including means-plus-function limitations, unless such a limitation is explicitly recited in a given claim using the phrase “means for.” Any element in a claim that does not explicitly state “means for” performing a specified function, is not to be interpreted as a “means” or “step” clause as specified in 35 USC §112, ¶6. In particular, the use of “step of” in the claims herein is not intended to invoke the provisions of 35 USC §112, ¶6.

What is claimed is:

1. A method, comprising:
performing simulations of metrology measurements of a structure on a metrology model of the structure at two or more different truncation orders up to a maximum truncation order;
fitting simulation results to a function of a form that reflects the fact that a truncation order of infinity is an analytic point that admits a Taylor series expansion;
extrapolating the function to a truncation order approaching infinity limit to obtain a high fidelity result;
obtaining fitted parameters for the function using simulation results for two or more lower truncation orders that are less than the maximum truncation by fitting the simulation results for the two or more lower truncation orders to the function; and
generating a simulated metrology signal by performing a simulation using an optimized truncation order that is less than the maximum truncation order, the function and the one or more fitted parameters

2. The method of claim 1, wherein the optimized truncation order is obtained by selecting a simulation result for which a difference between the simulation result and the measured data is within a desired margin of error and for which the behavior of the simulation results as a function of the truncation order admits the Taylor series and allows the use of the method of claim 1 with sufficient accuracy.

3. The method claim 1, wherein the method is performed by a truncation order optimizer incorporated in an optical metrology tool or a server independent from an optical metrology tool.

4. The method of claim 1, wherein the simulation results simulate measurements performed with a reflectometer, a scatterometer, an ellipsometer, or overlay tool.

5. The method of claim 1, further comprising, wherein the structure is a periodic structure.

6. The method of claim 1, further comprising optimizing a metrology model of the structure used to perform the simulations using the optimized truncation order for metrology measurements made at two or more different metrology configurations, using the fitting results of the simulations as a function of truncation order to determine different levels of fidelity, for these different configurations, and performing the fitting of the measured data to the simulation results in a way that weights each of the configurations while taking into account of their different fidelities.

7. The method of claim 6, wherein the metrology model includes one or more profile parameters of the structure.

8. The method of claim 7, further comprising obtaining a measured signal from the periodic structure by an optical metrology device and determining the one or more profile parameters using a measured scatterometry signal and the optimized optical metrology model.

9. The method of claim 1, wherein at least one of the two or more lower truncation orders or the optimized truncation order is less than half of the maximum truncation order.

10. A computer readable storage medium containing computer executable instructions for performing a method, the method comprising:
performing simulations of metrology measurements of a structure on a metrology model of the structure at two or more different truncation orders up to a maximum truncation order;
fitting simulation results to a function of a form that reflects the fact that a truncation order of infinity is an analytic point that admits a Taylor series expansion;
extrapolating the function to a truncation order approaching infinity limit to obtain a high fidelity result;
obtaining fitted parameters for the function using simulation results for two or more lower truncation orders that are less than the maximum truncation by fitting the simulation results for the two or more lower truncation orders to the function; and
generating a simulated metrology signal by performing a simulation using an optimized truncation order that is less than the maximum truncation order, the function and the one or more fitted parameters.

11. An optical metrology system, comprising:
a metrology tool;
a processor coupled to the metrology tool, the processor being configured to implement a method comprising:
performing simulations of metrology measurements of a structure on a metrology model of the structure at two or more different truncation orders up to a maximum truncation order;
fitting simulation results to a function of a form that reflects the fact that a truncation order of infinity is an analytic point that admits a Taylor series expansion;
extrapolating the function to a truncation order approaching infinity limit to obtain a high fidelity result;
obtaining fitted parameters for the function using simulation results for two or more lower truncation orders that are less than the maximum truncation by fitting the simulation results for the two or more lower truncation orders to the function; and
generating a simulated metrology signal by performing a simulation using an optimized truncation order that is less than the maximum truncation order, the function and the one or more fitted parameters.

12. The system of claim 11, wherein the metrology tool is an optical metrology tool.

13. The system of claim 12, wherein the metrology tool is a reflectometer.

14. The system of claim 12, wherein the metrology tool is an ellipsometer.

15. The system of claim 12, wherein the metrology tool is an overlay tool.

16. The system of claim 11, wherein the processor is part of the metrology tool.

17. The system of claim 11, wherein the processor is separate from the metrology tool.
